(19) United States
(12) Patent Application Publication
(10) Pub. No.: US 2026/0075009 A1
(43) Pub. Date: Mar. 12, 2026

(54) NETWORK DEVICE FOR PACKET SWITCHING IN ACCORDANCE WITH A BOUNDED END-TO-END DELAY, AND METHOD OF OPERATING THE SAME

(71) Applicant: HUAWEI TECHNOLOGIES CO., LTD., Shenzhen (CN)

(72) Inventors: Antoine Fressancourt, Boulogne Billancourt (FR); Paolo Medagliani, Boulogne Billancourt (FR); Sebastien Martin, Boulogne Billancourt (FR); Anne Bouillard, Boulogne Billancourt (FR); Shoushou Ren, Beijing (CN)

(73) Assignee: HUAWEI TECHNOLOGIES CO., LTD., Shenzhen (CN)

(21) Appl. No.: 19/327,910

(22) Filed: Sep. 12, 2025

Related U.S. Application Data
(63) Continuation of application No. PCT/CN2023/081365, filed on Mar. 14, 2023.

(51) Int. Cl. H04L 47/722; H04L 47/30

(52) U.S. Cl. CPC H04L 47/722; H04L 47/30

(57) ABSTRACT

Disclosed is a network device (1) for packet switching in accordance with a bounded end-to-end delay. The network device comprises a plurality (11) of n first-in first-out, FIFO, queues, being servable in accordance with a round-robin based service policy and a fixed packet processing time (T). A respective queue of the plurality is associated with a bounded delay (Dₘₐₓ) depending on the service policy of the plurality of queues and being a function of an adaptable buffer capacity (Bₑ) of the respective queue. The network device further comprises a processor (12), being configured to determine a threshold crossing of an extent of reservation of the buffer capacity of the respective queue; and to adapt the buffer capacity of the respective queue in accordance with the determined threshold crossing. This enables network devices of a network to trade off QoS and capacity locally in a distributed manner, without a centralized controller.

### CROSS-REFERENCE TO RELATED APPLICATIONS

This application is a continuation of International Application No. PCT/CN2023/081365, filed on Mar. 14, 2023, the disclosure of which is hereby incorporated by reference in its entirety.

### TECHNICAL FIELD

The present disclosure relates generally to the field of network communications, and particularly to a network device for packet switching in accordance with a bounded end-to-end delay, and to a method of operating the network device.

### BACKGROUND ART

In 5^{th} generation (5G) mobile network communications, many use cases require low (less than 100 ms) and/or deterministic latency. Examples include online gaming, virtual reality (VR), vehicle-to-everything (V2X) communication, mission critical user plane push-to-talk (PTT), mission critical video user plane, time-sensitive networking (TSN) and deterministic IP (DIP) communication. All these use cases can target long distance scenarios wherein a centralized controller may not be available.

Despite traditional queuing mechanisms, such as DiffServ, can already provide low latency, they fail to enforce determinism, i.e., to provide an upper bound to the delay that can be experienced by a flow using the queue. The bounded deterministic end-to-end latency can be guaranteed if any intermediary node is able to provide a bounded delay on its own part. With Best Effort (BE) networks, instead, the tail of the latency distribution can grow indefinitely.

Especially in long distance networks, meeting DetNet requirements (see IETF DetNet Working Group) in terms of latency and jitter bounds is difficult and requires consistent clock synchronization between devices that can be separated by the long distance. While jitter can be relaxed as packets can be buffered at the receiving end and delivered at the right time, what really matters is the latency bound. Relaxing the constraint on jitter thus allows thinking about alternatives to DetNet solutions.

### SUMMARY

Certain embodiments overcome the above-mentioned and other drawbacks. The foregoing and other objects are achieved by the features of the independent claims. Further implementation forms are apparent from the dependent claims, the description and the figures.

According to a first aspect, a network device is provided for packet switching in accordance with a bounded end-to-end delay. The network device comprises a plurality of n first-in first-out, FIFO, queues, being servable in accordance with a round-robin based service policy and a fixed packet processing time. A respective queue of the plurality is associated with a bounded delay depending on the service policy of the plurality of queues and being a function of an adaptable buffer capacity of the respective queue. The network device further comprises a processor, being configured to determine a threshold crossing of an extent of reservation of the buffer capacity of the respective queue; and to adapt the buffer capacity of the respective queue in accordance with the determined threshold crossing.

Leveraging on the adaptation of buffer capacities (and thus delay bounds) in response to an extent of reservation of the same enables the network devices of a network to trade off Qos and capacity
independently of one another in a distributed manner, without a centralized controller.

As used herein, packet switching may refer to a mode of data transmission in which a message is broken into a number of parts which are sent independently at a source terminal and reassembled at a destination terminal.

As used herein, a bounded end-to-end delay may refer to a delay/latency limit for an end-to-end communication between the source and destination terminals.

As used herein, a bounded delay may refer to a delay/latency limit for a portion of the end-to-end communication, such as an intermediary network device.

As used herein, first-in first-out (FIFO) may refer to a queuing approach wherein an item stored first (i.e., least recently) is retrieved first. In other words, a FIFO queue may refer to a data structure being accessible in a FIFO manner.

As used herein, a round-robin based service policy may refer to a scheduling approach wherein a plurality of queues is served in accordance with respective time slots of a cycle of time slots.

As used herein, a processor may refer to a network processor, an application-specific integrated circuit (ASIC), a field-programmable gate array (FPGA), a microprocessor, and the like.

As used herein, a threshold crossing may refer to an event wherein a value of a variable crosses a given threshold value, either upwardly (from below the threshold to above the same) or downwardly (from above the threshold to below the same).

In a possible implementation form, the service policy may comprise one of: a round robin, RR, service policy; a weighted round robin, WRR, service policy; a deficit round robin, DRR, service policy; a bandwidth-sharing service policy; a service policy that can guarantee a bounded delay independently of other queues of the plurality; and a service policy being in accordance with audio video bridging/time sensitive networking, AVB-TSN, standards.

Embracing various known service policies ensures broad applicability and enables re-using the corresponding theories and insights.

In a possible implementation form, the bounded delay may comprise a constant term and a term in dependence of the number of queues, the adaptable buffer capacity, the fixed packet processing time and the service policy.

Providing a relation between the bounded delay per network device and the adaptable buffer capacity of a FIFO queue of the same also renders the bounded delay adaptable (i.e., can be manipulated in a purposeful manner).

In a possible implementation form, for determining the threshold crossing of the extent of reservation of the buffer capacity of the respective queue, the processor may further be configured to determine the threshold crossing of the extent of reservation of the buffer capacity of the respective queue above a first threshold.

In a possible implementation form, for determining the threshold crossing of the extent of reservation of the buffer capacity of the respective queue, the processor may further be configured to determine the threshold crossing of the extent of reservation of the buffer capacity of the respective queue below a second threshold.

In a possible implementation form, for adapting the buffer capacity of the respective queue in accordance with the determined threshold crossing, the processor may further be configured, upon the threshold crossing above the first threshold, to increase the buffer capacity of the respective queue such that the current delay bound of the respective queue corresponds to a maximum of: the current delay bound of the respective queue, and a minimum delay bound of reservations of the respective queue.

Increasing the delay bound (via the buffer capacity) like this preserves the delay bounds of existing reservations.

In a possible implementation form, for adapting the buffer capacity of the respective queue in accordance with the determined threshold crossing, the processor may further be configured, upon the threshold crossing below the second threshold, to decrease the buffer capacity of the respective queue such that a threshold crossing of the extent of reservation of the buffer capacity of the respective queue above a third threshold between the first threshold and the second threshold is obtained.

Decreasing the delay bound (via the buffer capacity) like this increases the extent of reservation of the buffer capacity.

In a possible implementation form, the processor may further be configured to exchange adapted buffer capacities and associated bounded delays with an adjacent network device.

Exchanging adapted buffer capacities and associated bounded delays with adjacent network devices distributes the same within the whole network and enables all the network nodes to take routing decisions independently of one another.

As used herein, adjacent may refer to network nodes/devices being directly connected to a common network link.

In a possible implementation form, for exchanging the adapted buffer capacities and the associated bounded delays with the adjacent network device, the processor may further be configured to send an advertisement message to the adjacent network device. The advertisement message may comprise a network address of an advertising network device; an identifier of a respective queue of the advertising network device; the adapted buffer capacity of the respective queue of the advertising network device; and the bounded delay of the respective queue of the advertising network device.

As used herein, an advertisement message may refer to an extension of an advertisement (i.e., LSA) message of an interior gateway (routing) protocol, such as OSPF or IS-IS, or an exterior gateway (routing) protocol, such as BGP.

As used herein, a network address may refer to a unique identifier of a network device or a network interface that is significant within the corresponding network only. For instance, a deployment of Internet Protocol (IP) based network protocols requires using IP addresses.

In a possible implementation form, for exchanging the adapted buffer capacities and the associated bounded delays with the adjacent network device, the processor may further be configured to receive the advertisement message.

In a possible implementation form, for exchanging the adapted buffer capacities and the associated bounded delays with the adjacent network device, the processor may further be configured to configure the adapted buffer capacity and the bounded delay of the respective queue of the network device, given the network device matches the advertising network device.

In a possible implementation form, the processor may further be configured to compute a shortest path tree rooted at the network device in accordance with the exchanged bounded delays.

As used herein, a shortest-path tree may refer to a spanning tree of a network graph such that a path distance from a root node of the shortest-path tree to any other network node is a shortest path distance in said network graph.

In a possible implementation form, the processor may further be configured to send a reservation request message to a target network device. The reservation request message may comprise: a stack of recorded network addresses, comprising the network address of the network device; a target network address of the target network device; the requested bounded end-to-end delay between the network device and the target network device; and a requested buffer capacity.

A stack as used herein may refer to a data structure being accessible in a last-in first out (LIFO) manner. In other words, an item stored last (i.e., most recently) is retrieved first. Terminology-wise, items may be stored or ‘pushed’ on the stack and retrieved or ‘popped’ from the stack.

In a possible implementation form, the processor may further be configured to receive the reservation request message from an upstream network device. The reservation request message may comprise: the stack of recorded network addresses; the target network address of the target network device; the requested bounded end-to-end delay between the network device and the target network device; and the requested buffer capacity. If the target network address fails to match the network address of the network device, the processor may further be configured to: reserve the requested buffer capacity from the buffer capacity of the respective queue, push the network address of the network device onto the stack of recorded network addresses; and send the reservation request message to the target network device. The reservation request message may comprise: the stack of recorded network addresses, comprising the network address of the network device; the target network address; the requested bounded end-to-end delay minus the bounded delay of the respective queue, the minuend being greater than or equal to the subtrahend; and the requested buffer capacity. If the target network address matches the network address of the network device, the processor may further be configured to: store the reservation request message; and start a timer in accordance with a given expiry period. If the timer has expired, the processor may further be configured to: select a reservation request message of the stored reservation request messages in accordance with a given selection criterion; pop a network address from the stack of recorded network addresses of the selected reservation request message; and send a reservation response message to the popped network address. The reservation response message may comprise: the stack of recorded network addresses of the selected reservation request message; and the requested buffer capacity of the selected reservation request message.

Forwarding a reservation request message in accordance with the previously advertised bounded delay of the respective queue enables a distributed low-latency path reservation.

As used herein, a reservation request message may refer to an extension of a reservation request (i.e., PATH) message of a signaling protocol such as the Resource Reservation Protocol (RSVP). A similar extension of the Label Distribution Protocol (LDP) may also be suitable.

As used herein, a reservation response message may refer to an extension of a reservation response (i.e., RESV) message of a signaling protocol such as the Resource Reservation Protocol (RSVP). A similar extension of the Label Distribution Protocol (LDP) may also be suitable.

As used herein, upstream may refer to an adjacent network device being closer to an origin of a message, in accordance with a network metric.

In a possible implementation form, the given expiry period may comprise zero seconds.

In a possible implementation form, the given selection criterion may comprise a largest remainder of the requested bounded end-to-end delay of the stored reservation request messages.

In a possible implementation form, for sending the reservation request message to the target network device, the processor may further be configured to send the reservation request message to every adjacent network device except for the upstream network device.

Sending the reservation request message in accordance with this controlled flooding approach yields a simple yet straightforward signaling.

In a possible implementation form, the reservation response message may further comprise the requested bounded end-to-end delay received by the target network device.

Comprising the requested bounded end-to-end delay received by the target network device provides the residual portion of the originally requested bounded end-to-end delay to the requesting network device.

In a possible implementation form, the processor may further be configured to: receive the reservation response message from an adjacent network device; confirm the reservation of the required buffer capacity from the buffer capacity of the respective queue; pop a network address from the stack of recorded network addresses; and send the reservation response message to the popped network address. The reservation response message may comprise: the stack of recorded network addresses; and the requested buffer capacity.

According to a second aspect, a method of operating a network device for packet switching in accordance with a bounded end-to-end delay is provided. The network device comprises a plurality of n first-in first-out, FIFO, queues, being servable in accordance with a round-robin based service policy and a fixed packet processing time. A respective queue of the plurality being associated with a bounded delay depending on the service policy of the plurality of queues and being a function of an adaptable buffer capacity of the respective queue. The method comprises: determining a threshold crossing of an extent of reservation of the buffer capacity of the respective queue; and adapting the buffer capacity of the respective queue in accordance with the determined threshold crossing.

In a possible implementation form, the method may be performed by the network device of the first aspect or any of its implementations.

According to a third aspect, a computer program is provided, comprising a program code for performing the method of the second aspect or any of its implementations, when executed on a computer.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 schematically illustrates a network device in accordance with the present disclosure;

FIG. 2 schematically illustrates an exemplary network scenario for communication of advertisement messages;

FIG. 3 schematically illustrates an advertisement message in accordance with the present disclosure;

FIGS. 4A-4F schematically illustrate an exemplary network scenario for communication of reservation request messages and reservation response messages in accordance with the present disclosure;

FIG. 5 schematically illustrates a reservation request message in accordance with the present disclosure;

FIG. 6 schematically illustrates a reservation response message in accordance with the present disclosure; and

FIG. 7 schematically illustrates a flow chart of a method of operating a network device, in accordance with the present disclosure.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

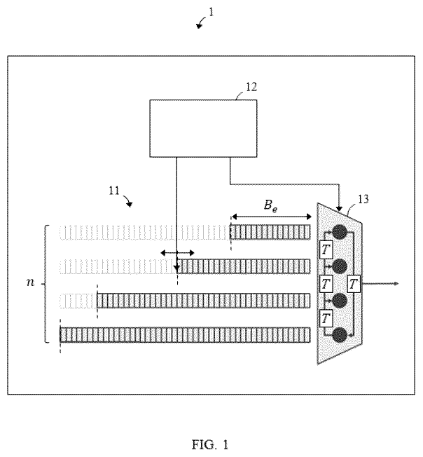

FIG. 1 schematically illustrates a network device 1 in accordance with the present disclosure.

The network device 1 is suited for packet switching in accordance with a bounded end-to-end delay 43 (see below).

The network device 1 comprises a plurality 11 of n first-in first-out, FIFO, queues, being servable in accordance with a round-robin based service policy and a fixed packet processing time T. FIG. 1 depicts a trapezium shape representing a scheduler 13, wherein the round-robin based service policy is indicated by a cyclic iteration of servers (black dots) in accordance with the fixed packet processing time T.

The service policy may comprise one of: a round robin, RR, service policy; a weighted round robin, WRR, service policy; a deficit round robin, DRR, service policy; a bandwidth-sharing service policy; a service policy that can guarantee a bounded delay independently of other queues of the plurality 11; and a service policy being in accordance with audio video bridging/time sensitive networking, AVB-TSN, standards.

A respective queue of the plurality 11 is associated with a bounded delay Dₘₐₓ depending on the service policy of the plurality 11 of queues and being a function of an adaptable buffer capacity Bₑ of the respective queue.

According to Network Calculus (see J.-Y. Le Boudec, P. Thiran, Network Calculus: A Theory of Deterministic Queuing Systems for the Internet, LNCS, vol. 2050, Springer, 2001), if the queues are served as FIFO and the buffer has capacity

$${B}_{e}^{k} ,$$

the delay can be expressed as [8].

$${T}_{0}^{e , k} + {B}_{e}^{k} / C I {R}_{e}^{k} ,$$

where

$${T}_{0}^{e , k}$$

is the worst-case delay, i.e., the maximum sojourn time, in the queue (which depends on assigned resources),

$${B}_{e}^{k}$$

is the buffer capacity of the queue k, and

$${CIR}_{e}^{k}$$

is the allocated committed information rate (CIR) on queue k. Assuming the CIR is fixed, the delay varies with the adjustable buffer capacity.

In modern packet processing pipelines, several physical queues are typically present to accommodate various types of traffic. Packets are taken from various hardware queues and sent in a round robin fashion. Hardware queues can be managed in software to throttle the capacity of each buffer or interleave packets in a hardware queue according to a policy. It is possible to set such switches to have a set of queues with increasing priority, for which the maximum queueing delay is given by

$${D}_{max} = {T}_{0} + {nB}_{e} T$$

where T₀ is a constant (floor), Bₑ is the buffer capacity (in units), T is the packet processing time and n is the number of queues to serve. According to this model, a larger buffer capacity Bₑ induces a larger queuing delay Dₘₐₓ.

In other words, the bounded delay Dₘₐₓ may comprise a constant term T₀ and a term in dependence of the number of queues n, the adaptable buffer capacity Bₑ, the fixed packet processing time T and the service policy.

The network device 1 further comprises a processor 12.

The processor 12 is configured to determine a threshold crossing of an extent of reservation of the buffer capacity Bₑ of the respective queue, and to adapt the buffer capacity Bₑ of the respective queue in accordance with the determined threshold crossing. FIG. 1 exemplifies the buffer capacity Bₑ of a first queue of the plurality 11 and an adaptation of the buffer capacity Bₑ of a second queue of the plurality 11.

For determining the threshold crossing of the extent of reservation of the buffer capacity Bₑ of the respective queue, the processor 12 may further be configured to determine the threshold crossing of the extent of reservation of the buffer capacity Bₑ of the respective queue above a first threshold or below a second threshold.

For instance, the first threshold may include 90%, and the second threshold may include 10%.

The network device 1 may observe the experienced QoS for the flows assigned to the respective queue of the plurality 11, as well as the extent of reservation of the buffer capacity Bₑ of the respective queue.

If the extent of reservation of the respective queue is high (≥first threshold), i.e., a respective queue lacks enough capacity for an additional flow, and the requested QoS (delay) for the additional flow is larger than the QoS (delay bound) provided by the buffer, then the network device 1 can increase the buffer capacity Bₑ of the respective queue to accept more traffic with relaxed QoS.

In other words, for adapting the buffer capacity Bₑ of the respective queue in accordance with the determined threshold crossing, the processor 12 may be configured, upon the threshold crossing above the first threshold (i.e., a high extent of reservation), to increase the buffer capacity Bₑ of the respective queue such that the current delay bound Dₘₐₓ of the respective queue corresponds to a maximum of: the current delay bound Dₘₐₓ of the respective queue, and a minimum delay bound of reservations of the respective queue.

By contrast, if the extent of reservation of the respective queue is low (≤first threshold), and a tighter QoS (delay) is requested then, if possible, the network device 1 may reduce the buffer capacity Bₑ of the respective queue, to accept traffic with tighter QoS.

That is to say, for adapting the buffer capacity Bₑ of the respective queue in accordance with the determined threshold crossing, upon the threshold crossing below the second threshold (i.e., a low extent of reservation), to decrease the buffer capacity Bₑ of the respective queue such that a threshold crossing of the extent of reservation of the buffer capacity Bₑ of the respective queue above a third threshold between the first threshold and the second threshold is obtained. For instance, the third threshold may include 35%.

The processor 12 may further be configured to advertise buffer capacities Bₑ (which have been adapted as explained above) and associated bounded delays Dₘₐₓ within the network as will be explained next.

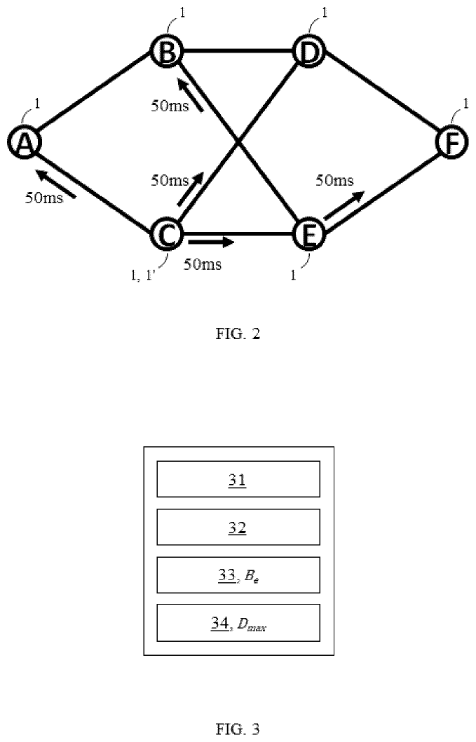

FIG. 2 schematically illustrates an exemplary network scenario for communication of advertisement messages 3.

The network scenario comprises a partially meshed plurality of network devices 1 identified as A-F.

Advertising buffer capacities Bₑ within this network scenario may require the respective network device 1 (viz., its processor 12) to be configured to exchange the adapted buffer capacities Bₑ and associated bounded delays Dₘₐₓ with one or more adjacent network devices 1.

In a sending network device 1, the processor 12 may be configured to send an advertisement message 3 to the adjacent network device(s) 1.

As used herein, an advertisement message 3 may refer to an extension of an advertisement (i.e., LSA) message of an interior gateway (routing) protocol, such as OSPF or IS-IS, or an exterior gateway (routing) protocol, such as BGP.

FIG. 3 schematically illustrates an advertisement message 3 in accordance with the present disclosure.

The advertisement message 3 may comprise a network address 31 of an advertising network device 1, 1′; an identifier 32 of a respective queue of the advertising network device 1, 1′; the adapted buffer capacity 33, Bₑ of the respective queue of the advertising network device 1, 1′; and the bounded delay 34, Dₘₐₓ of the respective queue of the advertising network device 1, 1′.

The advertisement message 3 may further comprise an extent of reservation of the adapted buffer capacity 33, Bₑ of the respective queue of the advertising network device 1, 1′.

As used herein, a network address 31 may refer to a unique identifier of a network device 1 or a network interface that is significant within the corresponding network only. For instance, a deployment of Internet Protocol (IP) based network protocols requires using IP addresses.

As used herein, a bounded delay may refer to a delay/latency limit for a portion of the end-to-end communication, such as an intermediary network device 1.

Returning to FIG. 2, in a receiving network device 1, the processor 12 may further be configured to receive the advertisement message 3.

FIG. 2 exemplifies a communication of advertisement messages 3 by network device 1, C. In this example, an adapted bounded delay 34, Dₘₐₓ=50 ms is advertised. The associated adapted buffer capacity 33, Bₑ is not shown for reasons of clarity.

Accordingly, a source willing to achieve a QoS target can find alternative paths respecting its QoS requirements.

For administrative configuration of buffer capacities 33, Bₑ and bounded delays 34, Dₘₐₓ of individual network devices 1 in a network, the processor 12 may further be adapted to configure the adapted buffer capacity 33, Bₑ and the bounded delay 34, Dₘₐₓ of the respective queue of the network device 1, given the network device 1 matches the advertising network device 1, 1′.

In accordance with the exchanged bounded delays 34, Dₘₐₓ, the processor 12 may further be configured to compute deadline objectives for each network device 1 on an end-to-end communication path, and/or compute a global deadline objective based on respective per-node delay budgets for each network device 1 on the end-to-end communication path.

In accordance with the exchanged bounded delays 34, Dₘₐₓ, the processor 12 may further be configured to (re-)compute a shortest path tree rooted at the network device 1.

The shortest path tree may comprise a Dijkstra tree, rooted at a target network device 1, 1″, wherein each network link is considered in the opposite direction, minimizing the end-to-end delay in accordance with the exchanged bounded delays 34, Dₘₐₓ. This scheme may be extended to consider more than a single queue per network device 1 by computing a Dijkstra tree per queue, and prioritizing the least feasible queue.

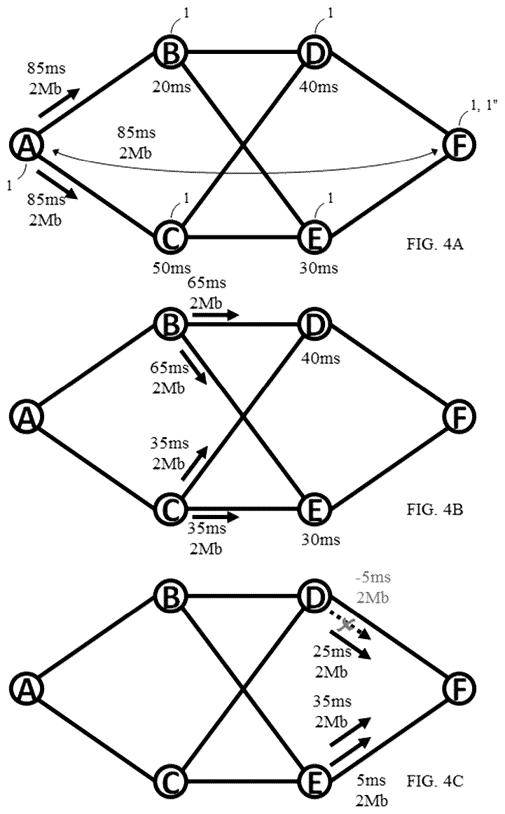

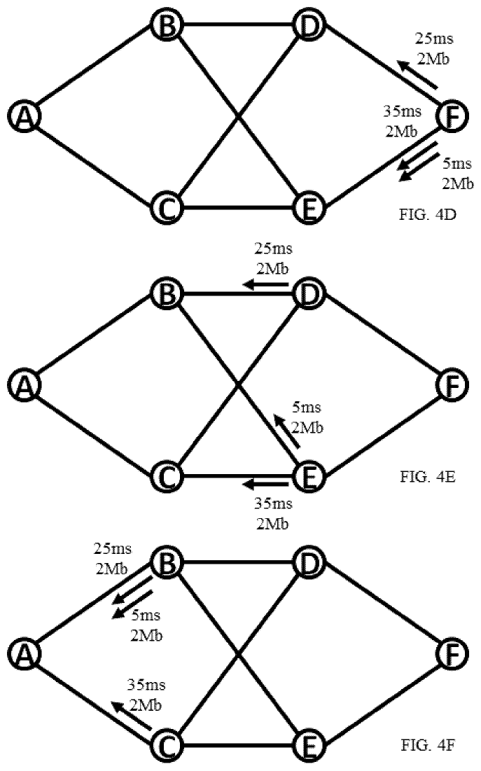

FIGS. 4A-4F schematically illustrate an exemplary network scenario for communication of reservation request messages 4 and reservation response messages 5 in accordance with the present disclosure.

As used herein, a reservation request message 4 may refer to an extension of a reservation request (i.e., PATH) message of a signaling protocol such as the Resource Reservation Protocol (RSVP). A similar extension of the Label Distribution Protocol (LDP) may also be suitable.

As used herein, a reservation response message 5 may refer to an extension of a reservation response (i.e., RESV) message of a signaling protocol such as the Resource Reservation Protocol (RSVP). A similar extension of the Label Distribution Protocol (LDP) may also be suitable.

In the depicted network scenario an end-to-end communication shall be signaled between a network device 1, A on the left of FIG. 4A and a target network device 1, 1″ on the right of FIG. 4A. The end-to-end communication shall have a requested bounded end-to-end delay 43 (i.e., a global deadline objective) of 85 ms and a requested buffer capacity 44 of 2 Mb as indicated by the end-to-end arrow.

In a sending network device 1, the processor 12 may be configured to send a reservation request message 4 to a target network device 1, 1″.

The (sent) reservation request message 4 may comprise: a stack 41 of recorded network addresses, comprising the network address 31 of the network device 1; a target network address 42 of the target network device 1, 1″; the requested bounded end-to-end delay 43 between the network device 1 and the target network device 1, 1″; and a requested buffer capacity 44.

For sending the reservation request message 4 to the target network device 1, 1″, the processor 12 may further be configured to send the reservation request message 4 to every adjacent network device 1 (i.e., neighbor) except for the upstream network device 1.

As used herein, upstream may refer to an adjacent network device being closer to an origin of a message, in accordance with a network metric.

The reservation request message 4 may further comprise additional requested bounded end-to-end delays 43 in accordance with different service level agreements (SLAs).

With reference to FIG. 4A, network device 1, A sends respective reservation request messages 4 to the target network device 1, 1″, F (i.e., to its neighbors or adjacent network devices 1, B, C). The respective reservation request message 4 comprises a stack 41 including the network address of A, the target network address 42 of F, the requested bounded end-to-end delay 43 of 85 ms and the requested buffer capacity 44 of 2 Mb.

In a receiving network device 1, the processor 12 may be configured to receive the reservation request message 4 from an upstream network device 1.

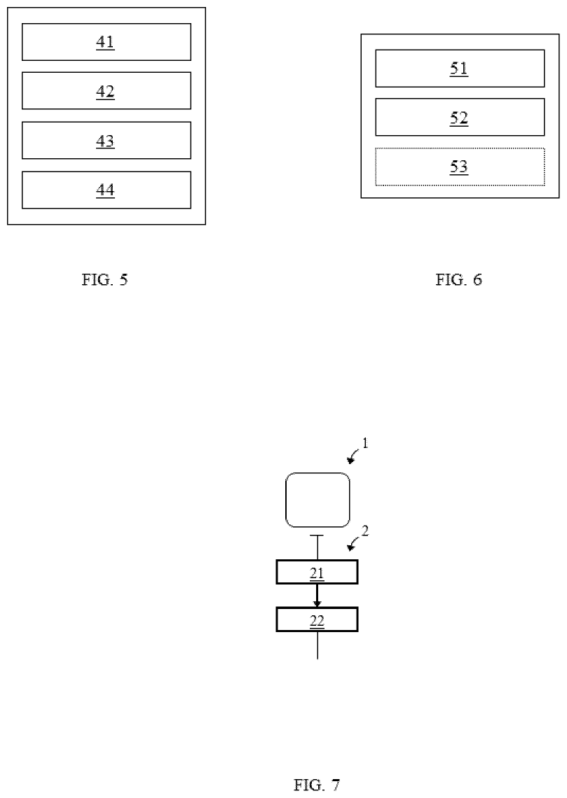

FIG. 5 schematically illustrates a reservation request message 4 in accordance with the present disclosure.

The (received) reservation request message 4 may comprise: the stack 41 of recorded network addresses; the target network address 42 of the target network device 1, 1″; the requested bounded end-to-end delay 43 between the network device 1 and the target network device 1, 1″; and the requested buffer capacity 44.

If the target network address 42 fails to match the network address 31 of the network device 1 (i.e., in intermediary network devices 1), the processor 12 may further be configured to: reserve the requested buffer capacity 44 from the buffer capacity Bₑ of the respective queue (the reservation being subject to a confirmation by a corresponding reservation response message 5, or to a timeout); push the network address 31 of the network device 1 onto the stack 41 of recorded network addresses; and send (forward) the reservation request message 4 to the target network device 1, 1″.

The (forwarded) reservation request message 4 may comprise: the stack 41 of recorded network addresses, comprising the network address 31 of the network device 1; the target network address 42; the requested bounded end-to-end delay 43 minus the bounded delay Dₘₐₓ of the respective queue, the minuend being greater than or equal to the subtrahend; and the requested buffer capacity 44.

Returning to FIG. 4B, network device 1, B receives the reservation request message 4 from its neighbor 1, A, reserves the requested buffer capacity 44 of 2 Mb, pushes the network address 31 of B onto the stack 41, subtracts the bounded delay Dₘₐₓ=20 ms from the requested bounded end-to-end delay 43 of 85 ms, resulting in a requested bounded end-to-end delay 43 of 65 ms (here, the minuend 85 ms is greater than the subtrahend 20 ms), and sends (forwards) the modified reservation request message 4 to the target network device 1, 1″, F (i.e., to its neighbors 1, D, E).

With continued reference to FIG. 4B, network device 1, C receives the reservation request message 4 from its neighbor 1, A, reserves the requested buffer capacity 44 of 2 Mb, pushes the network address 31 of C onto the stack 41, subtracts the bounded delay Dₘₐₓ=50 ms from the requested bounded end-to-end delay 43 of 85 ms, resulting in a requested bounded end-to-end delay 43 of 35 ms (here, the minuend 85 ms is greater than the subtrahend 50 ms), and sends (forwards) the modified reservation request message 4 to the target network device 1, 1″, F (i.e., to its neighbors 1, D, E).

With reference to FIG. 4C, network device 1, D receives the reservation request messages 4 from its neighbors 1, B, C, comprising requested bounded end-to-end delays 43 of 65 ms and 35 ms, respectively. In case of the reservation request message 4 from neighbor 1, B comprising the requested bounded end-to-end delay 43 of 65 ms, the network device 1, D reserves the requested buffer capacity 44 of 2 Mb, pushes the network address 31 of D onto the stack 41, subtracts the bounded delay Dₘₐₓ=40 ms from the requested bounded end-to-end delay 43 of 65 ms, resulting in a requested bounded end-to-end delay 43 of 25 ms (here, the minuend 65 ms is greater than the subtrahend 40 ms), and sends (forwards) the modified reservation request message 4 to the target network device 1, 1″, F. In case of the reservation request message 4 from neighbor 1, C comprising the requested bounded end-to-end delay 43 of 35 ms, subtracting the bounded delay Dₘₐₓ=40 ms from the requested bounded end-to-end delay 43 of 35 ms results in a requested bounded end-to-end delay 43 of −5 ms (here, the minuend 35 ms is less than the subtrahend 40 ms), so that no reservation request message 4 is sent (forwarded).

With continued reference to FIG. 4C, network device 1, E receives the reservation request messages 4 from its neighbors 1, B, C. In case of the reservation request message 4 from neighbor 1, B, the network device 1, E reserves the requested buffer capacity 44 of 2 Mb, pushes the network address 31 of E onto the stack 41, subtracts the bounded delay Dₘₐₓ=30 ms from the requested bounded end-to-end delay 43 of 65 ms, resulting in a requested bounded end-to-end delay 43 of 35 ms (here, the minuend 65 ms is greater than the subtrahend 30 ms), and sends (forwards) the modified reservation request message 4 to the target network device 1, 1″, F. In case of the reservation request message 4 from neighbor 1, C, the network device 1, E reserves the requested buffer capacity 44 of 2 Mb, pushes the network address 31 of E onto the stack 41, subtracts the bounded delay Dₘₐₓ=30 ms from the requested bounded end-to-end delay 43 of 35 ms, resulting in a requested bounded end-to-end delay 43 of 5 ms (here, the minuend 35 ms is greater than the subtrabend 30 ms), and sends (forwards) the modified reservation request message 4 to the target network device 1, 1″, F.

If the target network address 42 matches the network address 31 of the network device 1 (i.e., in the target network device 1, 1″), the processor 12 may further be configured to: store the reservation request message 4; and start a timer in accordance with a given expiry period.

Depending on the given expiry period, a number of reservation request messages 4 may be stored.

If the given expiry period comprises zero seconds, only a single (i.e., the first received) reservation request message 4 is stored.

With reference to FIG. 4C and assuming an adequate given expiry period, the target network device 1, 1″, F receives and stores the reservation request messages 4 from its neighbors 1, D, E, comprising (residual) requested bounded end-to-end delays 43 of 25 ms, 35 ms and 5 ms, respectively.

If the timer has expired, the processor 12 may further be configured to: select a reservation request message 4 of the stored reservation request messages 4 in accordance with a given selection criterion.

In particular, the given selection criterion may comprise a largest remainder of the requested bounded end-to-end delay 43 of the stored reservation request messages 4.

With reference to FIG. 4C and assuming the largest remainder as the given selection criterion, the target network device 1, 1″, F may select the reservation request message 4 from its neighbor 1, E comprising the (residual) requested bounded end-to-end delay 43 of 35 ms.

Without a given selection criterion, the processor 12 may be configured to: select all the stored reservation request messages 4.

In other words, in the presence of multiple valid requests respecting the end-to-end Qos requirements, the target network device 1, 1″, F may respond to one or more of them.

For each selected reservation request message 4, the processor 12 may further be configured to: pop a network address 31 from the stack 41 of recorded network addresses of the selected reservation request message 4; and send a reservation response message 5 to the popped network address 31.

FIG. 6 schematically illustrates a reservation response message 5 in accordance with the present disclosure.

The reservation response message 5 may comprise: the stack 51, 41 of recorded network addresses of the selected reservation request message 4; and the requested buffer capacity 52, 44 of the selected reservation request message 4.

The reservation response message 5 may further comprise the (residual) requested bounded end-to-end delay 53, 43 received by the target network device 1, 1″.

The processor 12 may further be configured to receive the reservation response message 5 from an adjacent network device 1.

With reference to FIG. 4D and assuming no given selection criterion, the target network device 1, 1″, F may select all the stored reservation request messages 4 comprising the (residual) requested bounded end-to-end delays 43 of 25 ms, 35 ms and 5 ms, respectively.

For each selected reservation request message 4, the target network device 1, 1″, F may pop a network address 31 from the respective stack 41; and send a reservation response message 5 to the respective popped network address 31 (i.e., to its neighbors 1, D, E).

In other words, the reservation response messages 5 are propagated back to the requesting network device 1, A following the inverse paths of the corresponding selected reservation request messages 4.

In turn, the network devices 1, D, E receive the reservation response messages 5 from the target network device 1, 1″, F.

For each received reservation response message 5, the processor 12 may further be configured to: confirm the reservation of the required buffer capacity from the buffer capacity Bₑ of the respective queue; pop a network address from the stack 41 of recorded network addresses; and send the reservation response message 5 to the popped network address.

With reference to FIG. 4E, network device 1, D confirms the reservation of the required buffer capacity of 2 Mb, pops the network address B from the stack 41, and sends (forwards) the reservation response message 5 to network device 1, B.

With continued reference to FIG. 4E, network device 1, E confirms the reservations of the required buffer capacities of 2 Mb, pops the network addresses (i.e., B, C) from the respective stacks 41, and sends (forwards) the respective reservation response message 5 to the network devices 1, B, C.

In turn, the network devices 1, B, C receive the reservation response messages 5 from the network devices 1, D, E.

With reference to FIG. 4F, network device 1, B confirms the reservations of the required buffer capacities of 2 Mb, pops the network addresses (i.e., A, A) from the respective stacks 41, and sends (forwards) the respective reservation response message 5 to the network device 1, A.

With continued reference to FIG. 4F, network device 1, C confirms the reservation of the required buffer capacity of 2 Mb, pops the network address A from the stack 41, and sends (forwards) the reservation response message 5 to network device 1, A.

At this point, the requesting network device 1, A may be provided with a number of options for the end-to-end communication in accordance with the requested bounded end-to-end delay 43 of 85 ms and the requested buffer capacity 44 of 2 Mb, and may make use one or more of them.

For example, instead of selecting the first path becoming available, the requesting network device 1 may wait for multiple paths becoming available and carry out a more advanced path selection policy (e.g., load balancing or meeting a specific deadline, . . . ). Note that multiple options may also be beneficial in terms of network resiliency (i.e., proactive protection measures or reactive restoration measures).

FIG. 7 schematically illustrates a flow chart of a method 2 of operating a network device 1, in accordance with the present disclosure.

The network device 1 corresponds to the implementation of FIG. 1, comprising a plurality 11 of n first-in first-out, FIFO, queues, being servable in accordance with a round-robin based service policy and a fixed packet processing time T. A respective queue of the plurality 11 is associated with a bounded delay Dₘₐₓ depending on the service policy of the plurality 11 of queues and being a function of an adaptable buffer capacity Bₑ of the respective queue.

The method 2 comprises a step of determining 21 a threshold crossing of an extent of reservation of the buffer capacity Bₑ of the respective queue.

The method 2 further comprises a step of adapting 22 the buffer capacity Bₑ of the respective queue in accordance with the determined threshold crossing.

The method 2 may be performed by the network device 1 of the first aspect or any of its implementations.

Although being designed for a distributed setting, the proposed capacity adaptation, advertisement and signaling schemes may also be carried out in a centralized setting.

In summary, the present disclosure combines a distributed mechanism, a buffer capacity reservation, a buffer capacity management (i.e., adaptation) and deterministic end-to-end QoS (i.e., delay) bounds.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. A network device (1) for packet switching in accordance with a bounded end-to-end delay (43), the network device (1) comprising
a plurality (11) of n first-in first-out, FIFO, queues,
being servable in accordance with a round-robin based service policy and a fixed packet processing time (T);
a respective queue of the plurality (11) being associated with a bounded delay (Dₘₐₓ) depending on the service policy of the plurality (11) of queues and being a function of an adaptable buffer capacity (Bₑ) of the respective queue; and
a processor (12), being configured to
determine a threshold crossing of an extent of reservation of the buffer capacity (Bₑ) of the respective queue; and
adapt the buffer capacity (Bₑ) of the respective queue in accordance with the determined threshold crossing.

2. The network device (1) of claim 1,
the service policy comprising one of:
a round robin, RR, service policy,
a weighted round robin, WRR, service policy,
a deficit round robin, DRR, service policy,
a bandwidth-sharing service policy,
a service policy that can guarantee a bounded delay independently of other queues of the plurality (11), or
a service policy being in accordance with audio video bridging/time sensitive networking, AVB-TSN, standards.

3. The network device (1) of claim 1 or claim 2,
the bounded delay (Dₘₐₓ) comprising
a constant term (T₀), and
a term in dependence of the number of queues (n), the adaptable buffer capacity (Bₑ), the fixed packet processing time (T) and the service policy.

4. The network device (1) of any one of the claims 1 to 3,
for determining the threshold crossing of the extent of reservation of the buffer capacity (Bₑ) of the respective queue, the processor (12) further being configured to
determine the threshold crossing of the extent of reservation of the buffer capacity (Bₑ) of the respective queue above a first threshold.

5. The network device (1) of any one of the claims 1 to 4,
for determining the threshold crossing of the extent of reservation of the buffer capacity (Bₑ) of the respective queue, the processor (12) further being configured to
determine the threshold crossing of the extent of reservation of the buffer capacity (Bₑ) of the respective queue below a second threshold.

6. The network device (1) of claim 4,
for adapting the buffer capacity (Bₑ) of the respective queue in accordance with the determined threshold crossing, the processor (12) further being configured to
upon the threshold crossing above the first threshold, increase the buffer capacity (Bₑ) of the respective queue such that the current delay bound (Dₘₐₓ) of the respective queue corresponds to a maximum of:
the current delay bound (Dₘₐₓ) of the respective queue, and
a minimum delay bound of reservations of the respective queue.

7. The network device (1) of claim 5,
for adapting the buffer capacity (Bₑ) of the respective queue in accordance with the determined threshold crossing, the processor (12) further being configured to
upon the threshold crossing below the second threshold, decrease the buffer capacity (Bₑ) of the respective queue such that a threshold crossing of the extent of reservation of the buffer capacity (Bₑ) of the respective queue above a third threshold between the first threshold and the second threshold is obtained.

8. The network device (1) of any one of the preceding claims,
the processor (12) further being configured to
exchange adapted buffer capacities (Bₑ) and associated bounded delays (Dₘₐₓ) with an adjacent network device (1).

9. The network device (1) of claim 8,
for exchanging the adapted buffer capacities (Bₑ) and the associated bounded delays (Dₘₐₓ) with the adjacent network device (1), the processor (12) further being configured to
send an advertisement message (3) to the adjacent network device (1), the advertisement message (3) comprising
a network address (31) of an advertising network device (1, 1′);
an identifier (32) of a respective queue of the advertising network device (1, 1′);
the adapted buffer capacity (33, Bₑ) of the respective queue of the advertising network device (1, 1′); and
the bounded delay (34, Dₘₐₓ) of the respective queue of the advertising network device (1, 1′).

10. The network device (1) of claim 8 or claim 9,
for exchanging the adapted buffer capacities (Bₑ) and the associated bounded delays (Dₘₐₓ) with the adjacent network device (1), the processor (12) further being configured to
receive the advertisement message (3).

11. The network device (1) of claim 10,
for exchanging the adapted buffer capacities (Bₑ) and the associated bounded delays (Dₘₐₓ) with the adjacent network device (1), the processor (12) further being configured to
configure the adapted buffer capacity (Bₑ) and the bounded delay (Dₘₐₓ) of the respective queue of the network device (1), given the network device (1) matches the advertising network device (1, 1′).

12. The network device (1) of any one of the claims 8 to 11,
the processor (12) further being configured to
compute a shortest path tree rooted at the network device (1) in accordance with the exchanged bounded delays (34, Dₘₐₓ).

13. The network device (1) of claim 12,
the processor (12) further being configured to
send a reservation request message (4) to a target network device (1, 1″), the reservation request message (4) comprising
a stack (41) of recorded network addresses, comprising the network address (31) of the network device (1);
a target network address (42) of the target network device (1, 1″);
the requested bounded end-to-end delay (43) between the network device (1) and the target network device (1, 1″); and
a requested buffer capacity (44).

14. The network device of claim 13,
the processor (12) further being configured to
receive the reservation request message (4) from an upstream network device (1), the reservation request message (4) comprising
the stack (41) of recorded network addresses;
the target network address (42) of the target network device (1, 1″);
the requested bounded end-to-end delay (43) between the network device (1) and the target network device (1, 1″); and
the requested buffer capacity (44);
if the target network address (42) fails to match the network address (31) of the network device (1):
reserve the requested buffer capacity (44) from the buffer capacity (Bₑ) of the respective queue;
push the network address (31) of the network device (1) onto the stack (41) of recorded network addresses; and
send the reservation request message (4) to the target network device (1, 1″), the reservation request message (4) comprising
the stack (41) of recorded network addresses, comprising the network address (31) of the network device (1);
the target network address (42);
the requested bounded end-to-end delay (43) minus the bounded delay (Dₘₐₓ) of the respective queue, the minuend being greater than or equal to the subtrahend; and
the requested buffer capacity (44); and
if the target network address (42) matches the network address (31) of the network device (1):
store the reservation request message (4); and
start a timer in accordance with a given expiry period;
if the timer has expired:
select a reservation request message (4) of the stored reservation request messages (4) in accordance with a given selection criterion;
pop a network address from the stack (41) of recorded network addresses of the selected reservation request message (4); and
send a reservation response message (5) to the popped network address (31), the reservation response message (5) comprising
the stack (51, 41) of recorded network addresses of the selected reservation request message (4); and
the requested buffer capacity (52, 44) of the selected reservation request message (4).

15. The network device (1) of claim 14,
the given expiry period comprising zero seconds.

16. The network device (1) of claim 14 or claim 15,
the given selection criterion comprising a largest remainder of the requested bounded end-to-end delay (43) of the stored reservation request messages (4).

17. The network device (1) of any one of the claims 13 to 16,
for sending the reservation request message (4) to the target network device (1, 1″), the processor (12) further being configured to
send the reservation request message (4) to every adjacent network device (1) except for the upstream network device (1).

18. The network device (1) of any one of the claims 14 to 17,
the reservation response message (5) further comprising
the requested bounded end-to-end delay (53, 43) received by the target network device (1, 1″).

19. The network device (1) of any one of the claims 12 to 18,
the processor (12) further being configured to
receive the reservation response message (5) from an adjacent network device (1);
confirm the reservation of the required buffer capacity from the buffer capacity (Bₑ) of the respective queue;
pop a network address from the stack (41) of recorded network addresses; and
send the reservation response message (5) to the popped network address, the reservation response message (5) comprising
the stack (51) of recorded network addresses; and
the requested buffer capacity (52, 44).

20. A method (2) of operating a network device (1) for packet switching in accordance with a bounded end-to-end delay (43),
the network device (1) comprising
a plurality (11) of n first-in first-out, FIFO, queues,
being servable in accordance with a round-robin based service policy and a fixed packet processing time (T);
a respective queue of the plurality (11) being associated with a bounded delay (Dₘₐₓ) depending on the service policy of the plurality (11) of queues and being a function of an adaptable buffer capacity (Bₑ) of the respective queue; and
the method (2) comprising
determining (21) a threshold crossing of an extent of reservation of the buffer capacity (Bₑ) of the respective queue; and
adapting (22) the buffer capacity (Bₑ) of the respective queue in accordance with the determined threshold crossing.

21. The method (2) of claim 20,
being performed by the network device (1) of any one of the claims 1 to 19.

22. A computer program comprising a program code for performing the method (2) of claim 20 or claim 21, when executed on a computer.
